(19) United States
(12) Patent Application Publication
(10) Pub. No.: US 2008/0184521 A1
(43) Pub. Date: Aug. 7, 2008

(54) CANISTER VACUUM CLEANER EQUIPPED WITH AIR CUSHION CASTER WHEEL ASSEMBLY

(76) Inventor: Eric J. Streciwilk, Perryville, KY (US)

Correspondence Address: KING & SCHICKLI, PLLC, 247 NORTH BROADWAY, LEXINGTON, KY, 40507, US

(21) Appl. No.: 12/017,484

(22) Filed: Jan. 22, 2008

Related U.S. Application Data
(60) Provisional application No. 60/887,858, filed on Feb. 2, 2007.

(51) Int. Cl. A47L 5/14; A47L 9/10; A47L 5/10; A47L 5/00; B60B 33/00

(52) U.S. Cl. 15/345; 15/347; 15/383; 15/246.2; 16/45

(57) ABSTRACT

A canister vacuum cleaner includes a housing carrying a suction generator and a dirt collection vessel. The housing is supported on a caster wheel assembly including a wheel riding on a cushion of air.

This application claims the benefit of U.S. Provisional Patent Application Ser. No. 60/887,858 filed Feb. 2, 2007.

### TECHNICAL FIELD

The present invention relates generally to the floor care equipment field and, more particularly, to a vacuum cleaner incorporating a novel air cushion caster wheel assembly.

### BACKGROUND OF THE INVENTION

A vacuum cleaner is an electro-mechanical appliance utilized to effect the dry removal of dust, dirt and other small debris from carpets, rugs, fabrics or other surfaces in domestic, commercial and industrial environments. In order to achieve the desired dirt and dust removal, most vacuum cleaners incorporate a rotary agitator. The rotary agitator is provided to beat dirt and debris from the nap of the carpet or rug while a pressure drop or vacuum is used to force air entrained with this dirt and debris into the nozzle of the vacuum cleaner. The particulate laden air is then drawn through a dirt collection vessel such as a bag-like filter, a removable dirt cup or a cyclonic separation chamber and filter combination, which traps the dirt, and debris while the substantially clean air is exhausted by an electrically operated fan that is driven by an onboard motor. It is this fan and motor arrangement that generates the drop in air pressure necessary to provide the desired cleaning action. Thus, the fan and motor arrangement is commonly known as the vacuum or suction generator.

The present invention relates to a vacuum cleaner equipped with a novel castor wheel assembly that relies on an air cushion to provide non-binding operation to allow smooth and efficient direction changes as the canister assembly is moved across the floor by the operator.

### SUMMARY OF THE INVENTION

In accordance with the purposes of the present invention as described herein, an improved canister vacuum cleaner is provided. The canister vacuum cleaner comprises a housing that carries a suction generator and a dirt collection vessel. In addition, the vacuum cleaner includes a support assembly that is carried on the housing. The support assembly includes a wheel.

More specifically, the support assembly includes a base member including a cavity for receiving the wheel. The base member includes a series of air ports communicating with that cavity. In addition, the support assembly includes a keeper for capturing the wheel in the cavity of the base member. The keeper includes an aperture and at least a portion of the wheel projects from that aperture.

Still further, the vacuum cleaner includes a conduit for directing at least a portion of the air being exhausted from the suction generator through the air ports into the cavity above the wheel. A seal, carried on one of the base member and the keeper, engages the wheel. The seal functions to maintain the resulting air cushion as the wheel rolls along the floor. As a result, the vacuum cleaner rides on a cushion of air at all times and the wheel is free to roll without binding. Thus, the vacuum cleaner is easily redirected in any direction by the operator.

In accordance with additional aspects of the present invention the vacuum cleaner includes a hose and a wand. Further, the vacuum cleaner includes a cleaning attachment. That cleaning attachment may take the form of a power head including a rotary agitator and an agitator drive motor. Still further, the vacuum cleaner may include a retractable power cord.

In one possible embodiment, the dirt collection vessel is a filter bag. In another possible embodiment the dirt collection vessel is a dirt cup. That dirt cup may include a cylindrical side wall, a tangentially directed inlet and an outlet in order to provide for cyclonic air flow. Still further, the vacuum cleaner includes a pair of wheels secured to the housing. The wheels function with the caster wheel assembly to allow the vacuum cleaner to be freely moved across the floor.

In accordance with yet another aspect of the present invention a castor wheel assembly is provided. The castor wheel assembly comprises a wheel, a base member including a cavity for receiving the wheel and a keeper for capturing the wheel in the cavity. The keeper includes an aperture and at least a portion of the wheel projects from that aperture.

Still further, the base member includes a series of air ports communicating with the cavity. Additionally, a seal is carried on one of the base member and the keeper and engages the wheel. Together, the air ports and the seal make it possible to maintain an air cushion between the base member and the wheel within the caster wheel assembly.

In the following description there is shown and described a preferred embodiment of this invention, simply by way of illustration of one of the modes best suited to carry out the invention. As it will be realized, the invention is capable of other different embodiments and its several details are capable of modification in various, obvious aspects, all without departing from the invention. Accordingly, the drawings and description will be regarded as illustrative in nature and not as restrictive.

### BRIEF DESCRIPTION OF THE DRAWING

The accompanying drawings incorporated herein and forming a part of this specification, illustrates several aspects of the present invention and together with the description serves to explain certain principles of the invention. In the drawings:

FIG. 1 is a perspective view of the canister vacuum cleaner of the present invention incorporating a novel support or canister wheel assembly;

FIG. 2 is a top plan view illustrating the internal structure of the canister vacuum cleaner illustrated in FIG. 1;

FIG. 3 is a schematical bottom plan view of the canister vacuum cleaner illustrated in FIG. 1;

FIG. 4 is a perspective view illustrating an alternative embodiment of a dirt collection vessel that may be provided in the canister vacuum cleaner of the present invention;

FIG. 5 is a detailed side elevational view of the support or caster wheel assembly;

FIG. 6 is a detailed perspective view illustrating the air ports in the base member of the assembly illustrated in FIG. 4;

FIG. 7 is a cross section view of the support or caster wheel assembly taken along line 7̅7̅ of FIG. 6;

FIG. 8 is a schematical view illustrating the conduit for feeding air from the suction generator to the caster wheel assembly;

FIG. 9 is a detailed perspective view similar to FIG. 6 but illustrating one possible alternative embodiment of the present invention; and

FIG. 10 is a cross sectional view of the embodiment illustrated in FIG. 9 taken along line 1 0̅1̅0̅ of FIG. 9.

Reference will now be made in detail to the present preferred embodiments of the invention, examples of which are illustrated in the accompanying drawings.

### DETAILED DESCRIPTION OF THE INVENTION

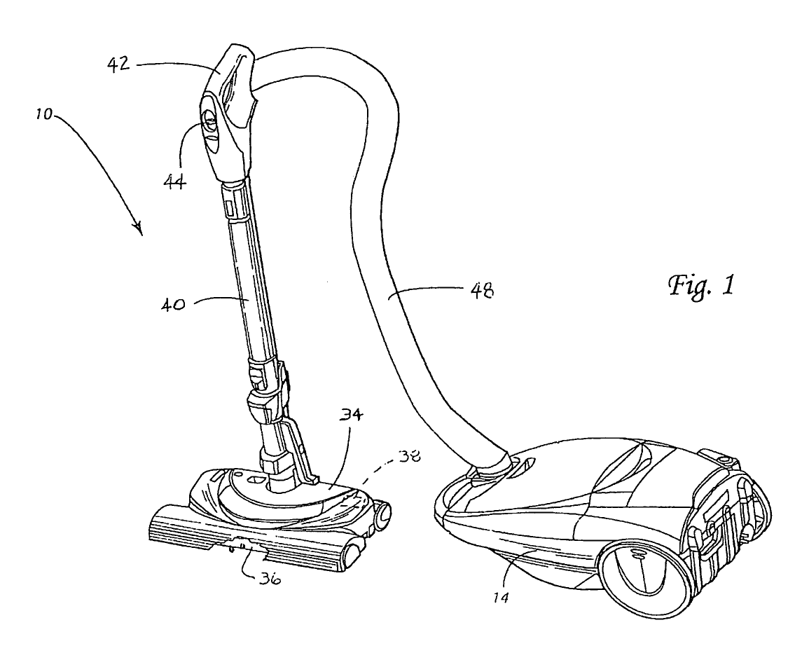

Reference is now made to FIGS. 1-3 illustrating the canister vacuum cleaner 10 of the present invention incorporating a novel support or caster wheel assembly 12. In the illustrated embodiment, the canister vacuum cleaner 10 includes a canister housing 14 that includes a receiver 16 for receiving a dirt collection vessel 18 used to collect dirt and debris in a manner known in the art. As illustrated in FIG. 1 the dirt collection vessel 18 is a filter bag.

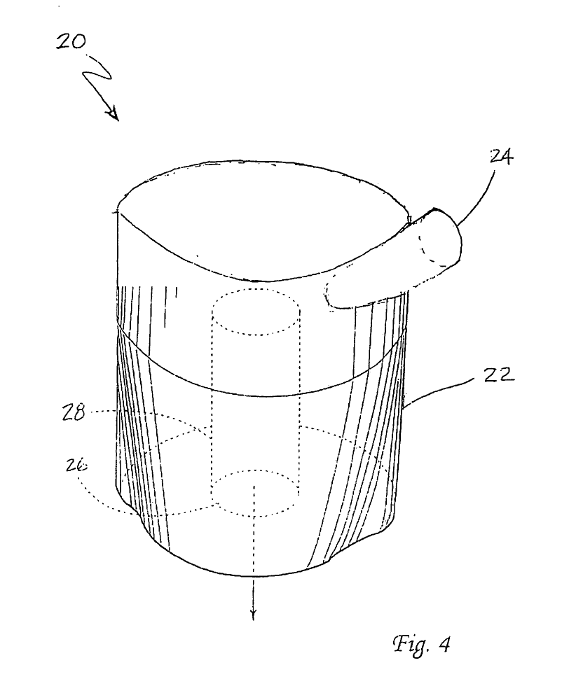

Alternatively, as illustrated in FIG. 4, the dirt collection vessel 18 may take the form of a dirt cup 20. The dirt cup 20 may include a cylindrical side wall 22, a tangentially directed inlet 24, and an axially directed outlet 26. Further, a main or primary filter 28 may be provided in the dirt cup over the outlet 26. The filter 28 may be cylindrically shaped and concentrically received within the side wall 22 of the dirt cup 20 so as to provide an annular space there between. The tangentially directed inlet promotes cyclonic air-flow within this annular space to enhance the cleaning efficiency of the vacuum cleaner 10 of this embodiment.

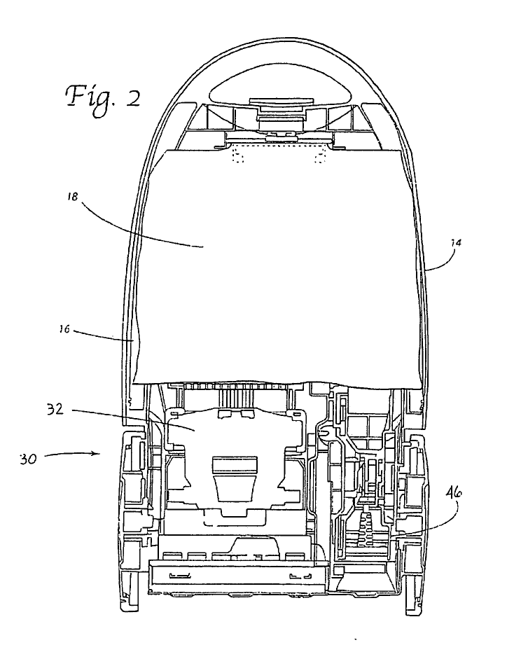

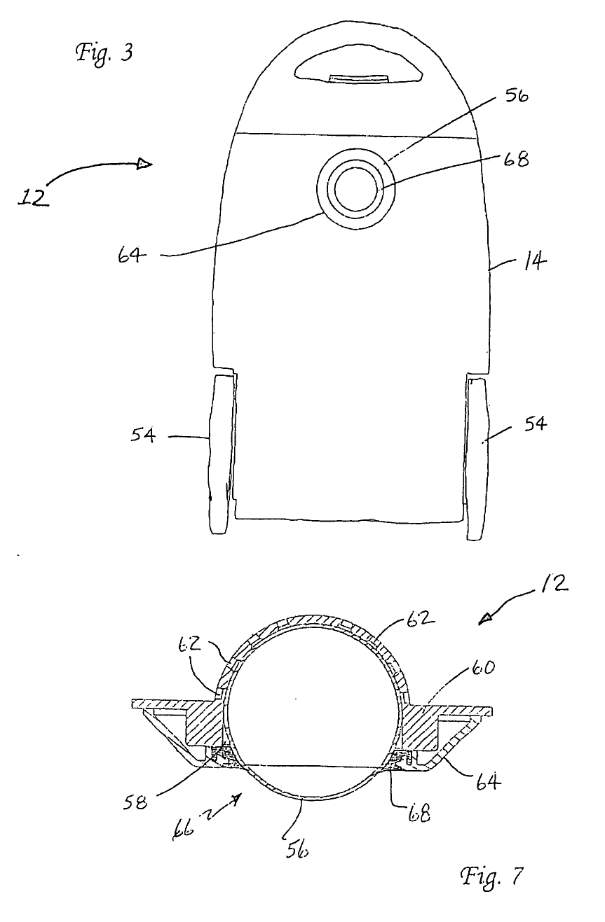

Referring back to drawing FIGS. 1 and 2, the canister housing 14 also includes a compartment 30 that receives a suction generator 32. The vacuum cleaner 10 also includes a cleaning attachment illustrated in the form of a power head or nozzle assembly 34. The nozzle assembly 34 includes a rotary agitator 36 and a rotary agitator drive motor 38. The nozzle assembly 34 is connected to a wand 40 including a control handle 42 incorporating an actuator 44 for turning the vacuum cleaner on and off. A cord reel 46 takes up and pays out an electrical cord (not shown), which is connected to an electrical wall outlet to provide power to the vacuum cleaner 10. A flexible hose 48 includes a cuff at the proximal end thereof that connects the wand 40 to the dirt collection vessel 18 in the canister housing 14. As best illustrated in FIG. 3, the canister housing 14 is supported for movement across the floor by means of the caster wheel assembly 12 adjacent the front of the canister housing and a pair of wheels 54 carried at the rear of the canister housing.

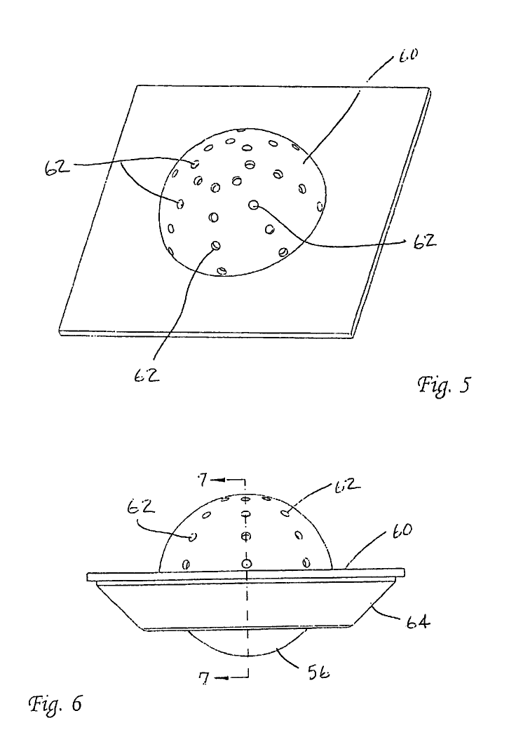

Reference is now made to FIGS. 5-7, which illustrate the caster wheel assembly 12 in detail. As illustrated, the caster wheel assembly 12 includes a spherical wheel 56 that is received in a cavity 58 formed in the base member 60. The wall of the base member 60 includes a series of air ports 62, the function of which will be described in greater detail below. A keeper 64 is secured to the base member 60 by any appropriate means including mechanical fastener, adhesive or the like. The keeper 64 includes a central aperture 66. When the spherical wheel 56 is captured in the cavity 58, a portion of the spherical wheel projects through the aperture 66 in the keeper 64. A seal 68 is secured to the keeper 64 and engages the spherical wheel 56. The seal 68 could be secured or directly mounted to the base member 60 if desired.

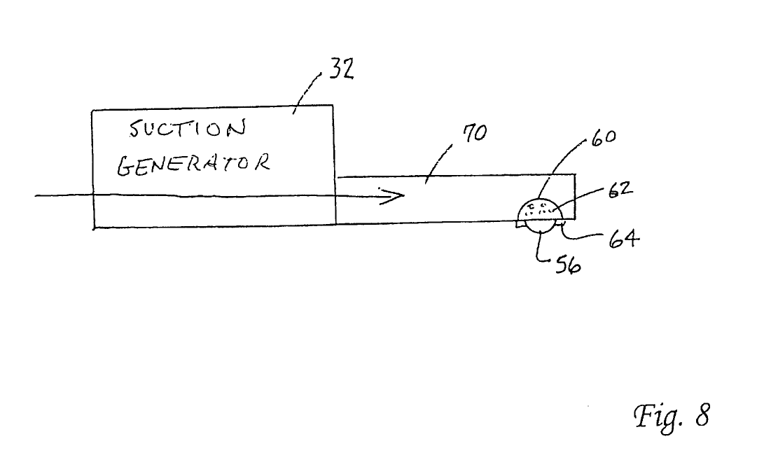

As further illustrated schematically in FIG. 8, a conduit 70 directs at least a portion of the air being exhausted from the suction generator 32 into the cavity 58 through the air ports 62. As noted above, the seal 68, engages the spherical wheel 56 closing the cavity 58. As a result, an air cushion is maintained in the cavity 58 between the base member 60 and the spherical wheel 56. Sufficient air pressure is provided to support the weight of the canister housing 14 freely floating above the spherical wheel 56. As a result, the spherical wheel 56 will not bind and is absolutely free to roll in substantially any direction. Thus, the operator may conveniently and easily direct the canister housing 14 when pulling it across the floor using the wand 40 and hose 48 of the vacuum cleaner 10.

The foregoing description of several preferred embodiments of the present invention have been presented for purposes of illustration and description. It is not intended to be exhaustive or to limit the invention to the precise form disclosed. Obvious modifications or variations are possible in light of the above teachings. For example, while the illustrated wheel 56 is spherical in shape, it should be appreciated that the wheel could assume other shapes including, but not limited to, cylindrical, cylindrical with ribs and/or valleys, spherical with ribs and/or valleys and two truncated cones joined at a common end.

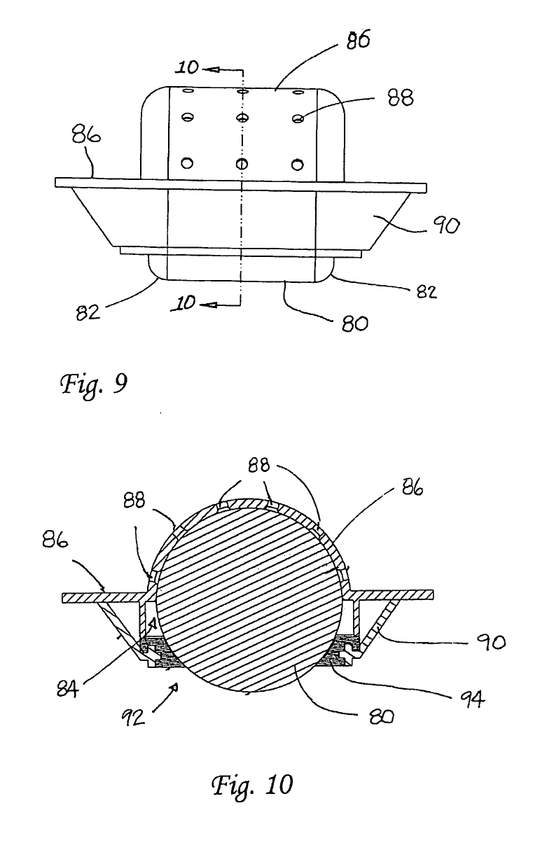

FIGS. 9 and 10 illustrate one of these possible alternative embodiments having a cylindrical wheel 80 with rounded margins 82. The wheel 80, like the wheel 56, is received in a cavity 84 formed in a base member 86. The wall of the base member 86 includes a series of air ports 88 that provide the cushion of air upon which the vacuum cleaner rides over the wheel 80. The wheel 80 is captured in the base member 86 by the keeper 90. A portion of the wheel 80 projects through an aperture 92 in the keeper 90. A seal 94 is secured to the keeper 90 and engages the wheel 80, closing the cavity.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1.) A canister vacuum cleaner, comprising:
a housing;
a suction generator carried on said housing;
a dirt collection vessel carried on said housing; and
a support assembly carried on said housing, said support assembly including a wheel riding on a cushion of air.

2.) The vacuum cleaner of claim 1, wherein said support assembly further includes a base member including a cavity for receiving said wheel.

3.) The vacuum cleaner of claim 2, wherein said support assembly further includes a keeper for capturing said wheel in said cavity of said base member.

4.) The vacuum cleaner of claim 3, wherein said keeper includes an aperture and at least a portion of said wheel projects from said aperture.

5.) The vacuum cleaner of claim 4, further including a seal carried on one of said base member and said keeper and engaging said wheel.

6.) The vacuum cleaner of claim 5, wherein said base member includes a series of air ports communicating with said cavity.

7.) The vacuum cleaner of claim 6, wherein said vacuum cleaner includes a conduit for directing at least a portion of air being exhausted from said suction generator through said air ports.

8.) The vacuum cleaner of claim 1, wherein said vacuum cleaner further includes a hose and a wand.

9.) The vacuum cleaner of claim 8, wherein said vacuum cleaner further includes a cleaning attachment.

10.) The vacuum cleaner of claim 9, wherein said cleaning attachment is a power head including a rotary agitator and an agitator drive motor.

11.) The vacuum cleaner of claim 1, wherein said vacuum cleaner includes a retractable power cord.

12.) The vacuum cleaner of claim 1, wherein said dirt collection vessel is a filter bag.

13.) The vacuum cleaner of claim 1, wherein said dirt collection vessel is a dirt cup.

14.) The vacuum cleaner of claim 13, wherein said dirt cup includes a cylindrical side wall, a tangentially directed inlet and an outlet.

15.) The vacuum cleaner of claim 1, wherein said vacuum cleaner includes a pair of wheels secured to said housing.

16.) The vacuum cleaner of claim 1, wherein said wheel is spherical in shape.

17.) The vacuum cleaner of claim 1, wherein said wheel is cylindrical in shape.

18.) A castor wheel assembly, comprising:
a wheel;
a base member including a cavity for receiving said wheel; and
a keeper for capturing said wheel in said cavity, said keeper including an aperture and at least a portion of said wheel projecting from said aperture.

19.) The assembly of claim 18 further including a seal carried on one of said base member and said keeper and engaging said wheel.

20.) The assembly of claim 19 wherein said base member includes a series of air ports communicating with said cavity.

21.) The assembly of claim 18, wherein said wheel is spherical in shape.

22.) The assembly of claim 18, wherein said wheel is cylindrical in shape.
